(19) United States
(12) Patent Application Publication
(10) Pub. No.: US 2026/0148422 A1
(43) Pub. Date: May 28, 2026

(54) TREE-BASED DEEP ENTROPY MODEL FOR POINT CLOUD COMPRESSION

(71) Applicant: InterDigital Patent Holdings, Inc., Wilmington, DE (US)

(72) Inventors: Muhammad Asad Lodhi, Highland Park, NJ (US); Jiahao Pang, Plainsboro, NJ (US); Dong Tian, Boxborough, MA (US)

(21) Appl. No.: 19/122,125

(22) PCT Filed: Oct. 17, 2023
(86) PCT No.: PCT/US2023/035302

§ 371 Date: Apr. 17, 2025

Related U.S. Application Data
(60) Provisional application No. 63/417,131, filed on Oct. 18, 2022.

(51) Int. Cl. G06T 9/00; G06T 9/40

(52) U.S. Cl. CPC G06T 9/001; G06T 9/40

(57) ABSTRACT

Methods and devices for encoding and decoding 3D point clouds. A learned deep entropy model over octrees is proposed for lossless compression of 3D point cloud data. The self-supervised compression consists of an adaptive entropy coder which operates on a tree-structured conditional entropy model. The information from the local neighborhood as well as the global topology is utilized from the octree structure. In an embodiment, the features from the parent level is up-sampled to bring them to the resolution of the current level before further feature aggregation. For processing dense massive point clouds and to facilitate parallel processing, a block-based compression scheme is proposed to reduce the required computation and time resources.

### 1. TECHNICAL FIELD

The present principles generally relate to the domain of point cloud processing. This field aims to develop the tools for analysis, interpolation, representation and understanding of point cloud signals. The present document is also understood in the context of the encoding, the formatting and the decoding of data representative of a point cloud for a 3D rendering on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Point cloud is a data format across several business domains from autonomous driving, robotics, augmented and/or virtual reality (AR/VR), civil engineering, computer graphics, to the animation/movie industry. 3D Light Detection and Ranging sensors (LIDAR) have been deployed in self-driving cars, and affordable LIDAR sensors are released from various companies. With great advances in sensing technologies, 3D point cloud data becomes more practical than ever and is expected to be an ultimate enabler in the applications mentioned.

Point cloud data is also believed to consume a large portion of network traffic, e.g., among connected cars over 5G network, and immersive communications (VR/AR). Point cloud understanding and communication would essentially lead to efficient representation formats. In particular, raw point cloud data need to be properly organized and processed for the purposes of world modeling & sensing. Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different time.

3D point cloud data comprise discrete samples on the surfaces of objects or scenes. Fully representing the real world with point samples requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power. A first step for any processing or inference on the point cloud is to have efficient storage methodologies. To store and process the input point cloud with affordable computational cost, one solution is to down-sample it first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down-sampled) into a bitstream through entropy coding techniques for lossless compression. Better entropy models result in a smaller bitstream and hence more efficient compression. Additionally, the entropy models can be also paired with downstream tasks which allow the entropy encoder to maintain the task specific information while compressing. Octrees are a format for encoding point clouds of any kind.

A Point Cloud Compression (PCC) method that using a deep entropy model learned over octrees, which provides efficient compression performance with control over the level of details by varying the depth of the tree or the quantization level of the input point cloud is missing.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate a method for decoding a tree-structured point cloud from a bitstream. The method comprises obtaining a node from a bitstream representative of a compressed tree-structured point cloud and initializing context information for the node. An occupancy symbol distribution for the node is predicted by using a learning-based entropy model utilizing the context information of the node and feature information from neighboring nodes and a parent node previously obtained from the bitstream. An occupancy symbol for the node is decoded, using an adaptive entropy decoder based on the occupancy symbol distribution. An expanded tree is output based on the occupancy symbol.

In an embodiment, the entropy model uses the deep feature information of sibling nodes of the parent of anode through a learning-based module used for siblings of the node, to predict the occupancy symbol distributions. In another embodiment, the entropy model uses the deep feature information of all nodes at a parent level through a learning-based module used for siblings of the node, to predict the occupancy symbol distributions. In yet another embodiment, the entropy model uses the deep feature information of all nodes at a parent level through a separate learning-based module, to predict the occupancy symbol distributions.

The present document also relates to a device comprising a memory associated with a processor configured for implementing the method above.

The present principles relate a method for encoding a tree-structured point cloud in a bitstream. The method comprises obtaining a structured point cloud as a tree. For each node of the tree context information is initialized, an occupancy symbol distribution is predicted by using a learning-based entropy model utilizing the context information of the node and feature information from neighboring nodes and a parent node of the node, and an occupancy symbol is encoded into a bitstream by using an adaptive entropy encoder based on the occupancy symbol distribution. A combined bitstream is generated for the tree.

The present document also relates to a device comprising a memory associated with a processor configured for implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 depicts an encoding method of a 3D point cloud according to the present principles;

FIG. 2 depicts a decoding method according to the present principles;

FIG. 3 depicts an architecture of a deep entropy model according to the present principles;

FIG. 4 shows an implementation of the deep entropy coding module in an encoder, according to a first embodiment of the present principles;

FIG. 5 shows an implementation of the deep entropy coding module, according to a second embodiment of the present principles;

FIG. 6 shows an implementation of the deep entropy coding module, according to a fourth embodiment of the present principles;

FIGS. 7A, 7B and 7C illustrate a sixth embodiment of the present principles;

FIG. 8 diagrammatically shows a transformer block used in a fourth variant of the sixth embodiment of the present principles;

FIG. 9 illustrates a deep entropy coding/decoding method where features from the parent level are up-sampled to match the resolution of the current octree level;

FIGS. 10 and 11 illustrate a scenario of the present principles in which the raw point cloud is converted into blocks via a shallow octree;

FIG. 12 shows an example architecture of a device configured to implement an encoding and/or decoding method described in relation to FIGS. 1-11; and

FIG. 13 shows an example of an embodiment of the syntax of a stream when the data are transmitted over a packet-based transmission protocol.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

The automotive industry and autonomous car are domains in which point clouds may be used. Autonomous cars should be able to “probe” their environment to make good driving decisions based on the reality of their immediate surroundings. Typical sensors like LIDARs produce (dynamic) point clouds that are used by the perception engine. These point clouds are not intended to be viewed by human eyes and they are typically sparse, not necessarily colored, and dynamic with a high frequency of capture. They may comprise other attributes like the reflectance ratio provided by the LIDAR as this attribute is indicative of the material of the sensed object and may help in making a decision.

Virtual Reality (VR) and immersive worlds have become a hot topic and foreseen by many as the future of 2D flat video. The basic idea is to immerse the viewer in an environment all around him as opposed to standard TV where he can only look at the virtual world in front of him. There are several gradations in the immersivity depending on the freedom of the viewer in the environment. Point cloud is a good format candidate to distribute VR worlds. They may be static or dynamic and are typically of average size, say no more than millions of points at a time.

Point clouds may be also used for various purposes such as culture heritage/buildings in which objects like statues or buildings are scanned in 3D in order to share the spatial configuration of the object without sending or visiting it. Also, it is a way to ensure preserving the knowledge of the object in case it may be destroyed, for instance, a temple by an earthquake. Such point clouds are typically static, colored, and huge.

Another use case is in topography and cartography in which using 3D representations, maps are not limited to the plane and may include the relief Google Maps is now a good example of 3D maps but uses meshes instead of point clouds. Nevertheless, point clouds may be a suitable data format for 3D maps and such point clouds are typically static, colored, and huge.

World modeling and sensing via point clouds could be an essential technology to allow machines to gain knowledge about the 3D world around them, which is crucial for the applications discussed above.

Point cloud compression refers to the problem of succinctly representing the surface manifold of the object(s) contained within a point cloud. Several approaches for this problem have been explored and may be split into the following categories: PCC in the input domain, PCC in the primitive domain, PCC in the transform domain, and PCC via entropy coding. PCC in the input domain refers to down-sampling the raw point cloud by choosing or generating points that are representative of the underlying surface manifold. Although several learned (deep learning based) and classical machine learning techniques exist in this area, PCC in the input domain is only suitable for low compression rates as the one is restricted to remain in the input domain and is mostly used for summarizing point clouds for further downstream processing. PCC in the primitive domain is also closely related to this area, where instead of key points primitives (regular geometric 2D/3D shapes) are generated that aim to closely follow the underlying object manifold. PCC in the transform domain refers to the case when the raw point cloud data is first transformed into another domain via learning-based or classical methods and then this representation in the new domain is compressed to obtain more efficient compression. Finally, is the case of PCC via entropy coding in which either the raw point cloud data or another (trivially obtained) representation of the point cloud is entropy coded via either adaptive learning-based or classical methods.

The present principles relate to this final case of PCC via entropy coding, and further falls under the category of learned hierarchical entropy models. Existing learned hierarchical entropy works for point clouds utilize only immediate information in the chain of hierarchy. According to the present principles, the immediate neighborhood information is not only integrated at the current hierarchical level, but the global information available is also integrated at the upper hierarchical level. The present principles aim to perform point cloud compression as a standalone method as well as for subsequent machine tasks (e.g., classification, segmentation, etc.). The aim of the present principles is to pertain to lossless compression of the relevant point cloud geometry data and handling of other features such as color or reflectance.

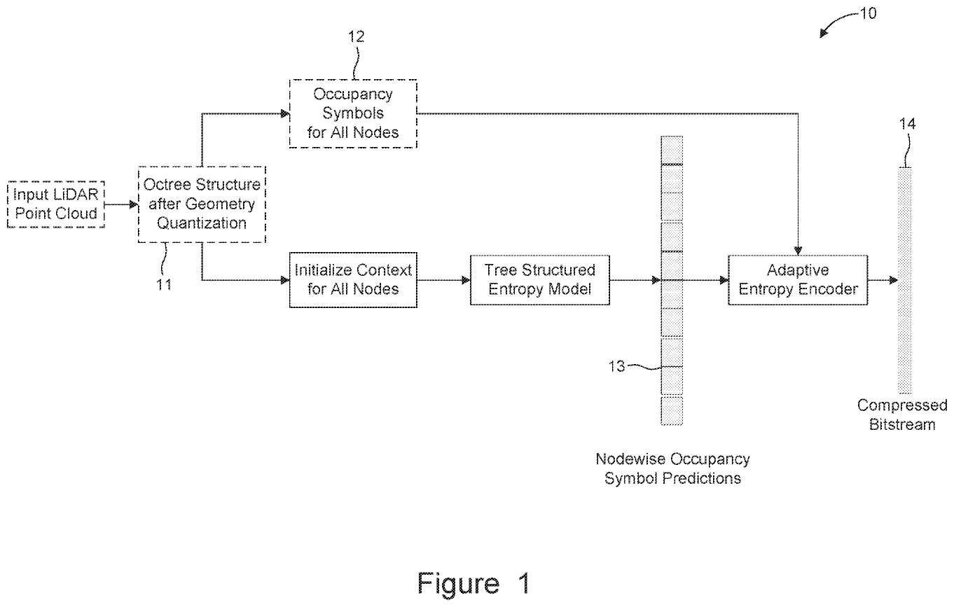

FIG. 1 depicts an encoding method 10 of a 3D point cloud according to the present principles. For a point cloud encoding system, an input point cloud X with N points, is first processed (i.e., transformed). For example, it can be quantized up to a certain precision resulting in M points. These M points are then further converted into a tree representation up to a certain specified tree depth. Possible tree representation comprises an octree representation, quadtree plus binary tree (QTBT) representation, or prediction tree representation, etc. An octree representation is a straightforward way to divide and represent positions in the 3D space, where a cube containing the whole point cloud is subdivided into 8 sub-cubes. An 8-bit code, called an occupancy code or occupancy symbol, is then generated by associating a 1-bit value with each sub-cube. It is to indicate whether a sub-cube contains points (i.e., with value 1) or not (i.e., with value 0). This division process is performed recursively to form a tree, where only sub-cubes with more than one point is further divided. Similar to the octree representation, QTBT also divides the 3D space recursively but allows more flexible division using quadtree or binary tree. It is particularly useful for representing sparse distributed point clouds. Different from octree and QTBT which divide the 3D space recursively, a prediction tree defines the prediction structure among the 3D points in a 3D point cloud. Geometry coding using prediction tree mainly benefits the Category 3 contents (LiDAR sequence) in PCC. With this conversion step, the compression of the raw point cloud geometry becomes the compression of the tree representation.

In the present document, the octree representation is used as an example representation without loss of generality. With the original point cloud converted into an octree structure 11, a deep learning based conditional tree structured entropy model is used to predict the occupancy symbol distributions 12 for all nodes in the tree. This conditional entropy model operates in a nodewise fashion and provides the occupancy symbol distribution 13 of a node depending on its context and features from neighboring nodes in the tree. The occupancy symbol of a node refers to the binary occupancy of each of its eight child nodes and is represented as an 8-bit integer from the 8-bit binary child occupancies. The context of a given node contains the following information: occupancy of the parent node as an 8-bit integer, the octree depth/level of the given node, the octant of the given node, and finally the spatial position of the current node. The conditional symbol distribution is then fed into a lossless adaptive entropy coder which compresses each node occupancy resulting in a bitstream 14.

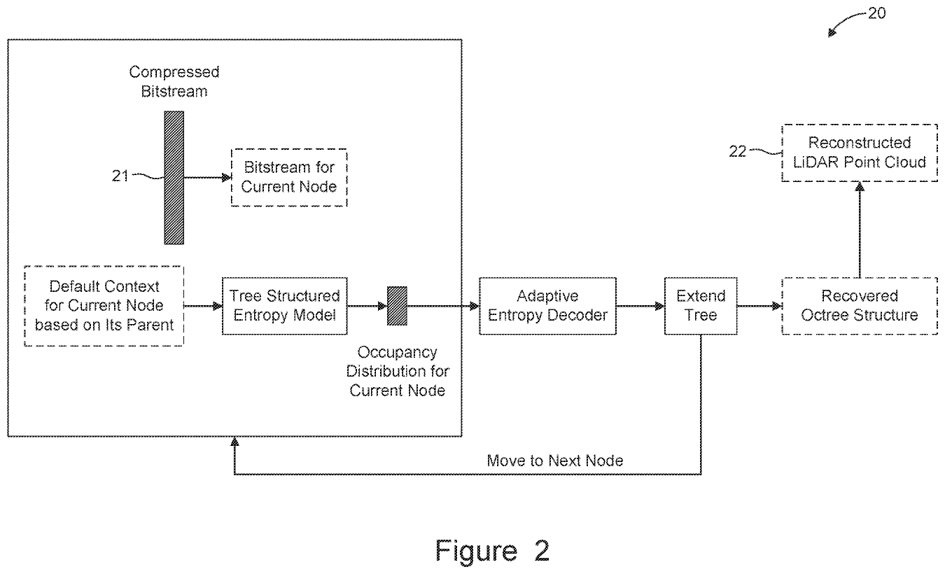

FIG. 2 depicts a decoding method 20 according to the present principles. Given a compressed bitstream 21 of a point cloud, the decoding method starts by first generating the default context for the root node. Then the deep entropy model generates the occupancy symbol distribution using the default context of the root node. The adaptive entropy decoder uses this distribution along with the part of the bitstream corresponding to the root node to decode the root occupancy symbol. The context of all children of the root node can now be initialized and the same procedure can be iterated several times to extend and decode the whole tree structure. After the whole tree is decoded, it is converted back to obtain the reconstructed point cloud 22.

A deep entropy model is applied to predict the occupancy symbol distribution, for example like in “OctSqueeze: Octree-Structured Entropy Model for LiDAR Compression” by Huang. Lila, et al. in Proceedings of the IEEE/CVF Conference on Computer Vision and Pattern Recognition. 2020. However, unlike this method which predicts the distribution with only the local information from the parent nodes, according to the present principles, more global information is available. Specifically, when predicting the occupancy symbol distribution of a current node, information from the sibling nodes is considered as well as all the ancestor nodes.

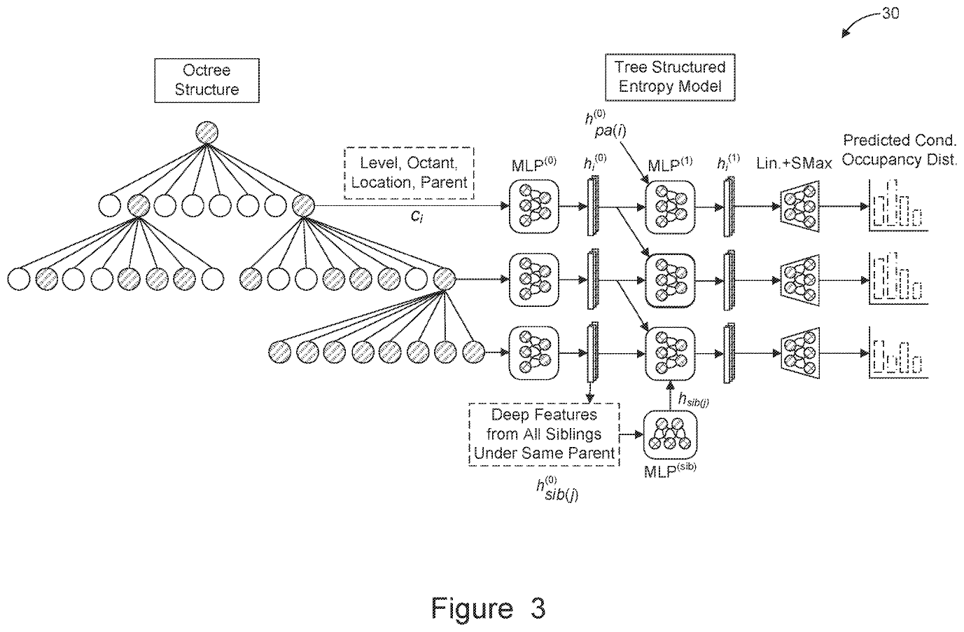

FIG. 3 depicts an architecture of a deep entropy model 30 according to the present principles. Given an octree structure, a deep conditional tree structured entropy model is trained. This conditional entropy model operates in a nodewise fashion (whose operation can be parallelized) and predicts the probability distribution for the occupancy symbol of a node depending on its context and its neighboring nodes, comprising its sibling nodes and its ancestor nodes. This conditional occupancy symbol distribution is then further used by either the adaptive entropy encoder or decoder to compress or decompress the tree structure as illustrated in FIGS. 1 and 2. To train the deep entropy model, the octree representation of a point cloud dataset containing numerous individual point clouds is used. The model takes the context of each node and features from its neighbors as input, and outputs the conditional occupancy symbol distribution. Then, cross entropy loss on the i-th node is computed as lᵢ=

$$- {\sum }_{j = 1}^{256} {y}_{ij} log {q}_{ij} ,$$

where y_{i,j} is the one-hot encoded ground truth symbol of the i-th node, and where qᵢ represents the predicted distribution of the symbols for the i-th node. The network is trained to minimize this loss over all nodes in all octrees in a self-supervised fashion.

Existing methods for point cloud compression only train over one input precision and use that trained model to compress point clouds at several different input precisions. This procedure is sub-optimal and results in poor compression performance for the input precisions not encountered during the training phase. According to the present principles, the model is trained at a set of highest geometry precision as well as at several quantized versions (low resolution version of the point cloud) of the input. A quantized version of a point cloud is obtained by quantizing the positions of the points in the point cloud through multiplication by a factor with value less than 1. Such training enables the model to perform at several levels of precision. This results in more robust training and provides better generalization.

In addition to the precision of the point cloud, the distribution of points within the point cloud is also taken into account. As different acquisition modalities result in vastly different distributions of the points in the raw point cloud, the model is trained on one kind of data, e.g., LiDAR, or VR/AR data, when high compression rates are required. However, if a more general model is required that on average performs well over several different kinds of datasets, then different types of datasets can be combined into one and then the model can be trained on this combined dataset. So, the present training scheme is adaptable to the target application and the target compression performance.

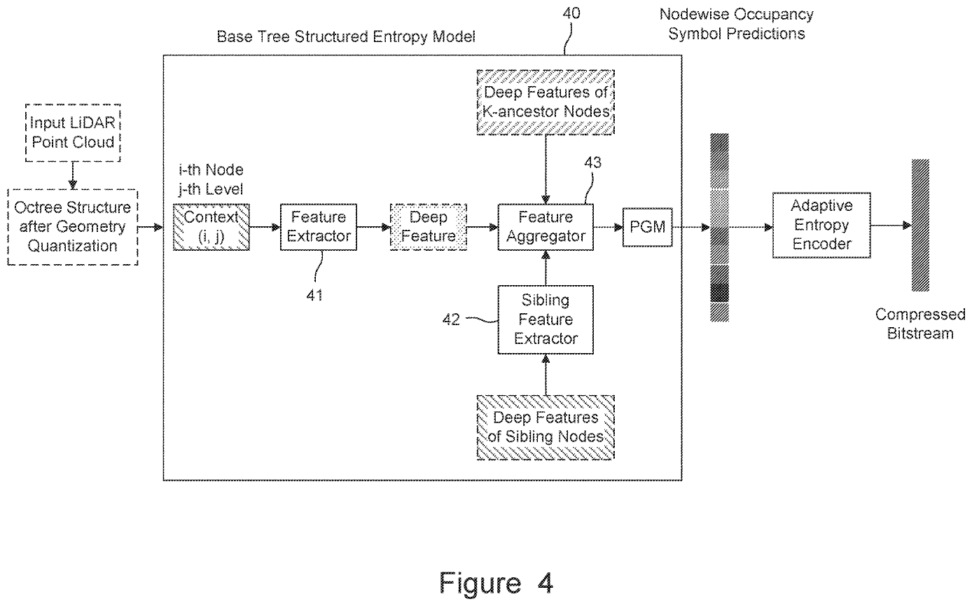

FIG. 4 shows an implementation of the deep entropy coding module in an encoder, according to a first embodiment of the present principles. In this first embodiment, the conditional entropy model incorporates deep features of the sibling nodes to predict the occupancy symbols of all sibling nodes simultaneously. This embodiment contrasts with the state-of-the-art where this neighborhood information from the siblings is not fully exploited. Let context of a given node i be represented as the vector ci. Furthermore, consider a deep neural network consisting of several back-to-back Multilayer Perceptron (MLP) modules, where the k-th MLP module is denoted by MLP^{(k)}. Then, the initial deep feature of a particular node is obtained as

$${h}_{i}^{( 0 )} = {MLP}^{( 0 )} ( {c}_{i} ) .$$

Starting with this initial feature for each node, which can be obtained in parallel, subsequent deep features can be obtained (also in parallel) as

$${h}_{i}^{( k )} = {MLP}^{( k )} ( {h}_{i}^{( k - 1 )} , {h}_{pa ( i )}^{( k - 1 )} ) , where {h}_{pa ( i )}^{( k - 1 )}$$

is the deep feature of the parent node of the given i-th node from the MLPC^{(k-1)}. It should be noted here that each MLP^{(k)} is shared between all nodes. The final MLP, denoted by MLP^{(K)}, is special as it takes an additional deep feature as input which is constructed from the deep features of all sibling nodes as

$${h}_{sib ( i )} = max ( {MLP}^{( sib )} ( {h}_{sib ( i )}^{( K - 1 )} ) ) ,$$

where MLP^{(sib)} first operates individually on deep features of each sibling node of the i-th node (including itself) and then the pooling function (e.g., max(⋅)) operates on the resulting features in each dimension to produce an overall combined deep feature of the same length as the input features. In this way, the final deep feature of the i-th node is obtained as

$${h}_{i}^{( K )} = {MLP}^{( K )} ( {h}_{i}^{( K - 1 )} , {h}_{sib ( i )} , {h}_{pa ( i )}^{( K - 1 )} ) .$$

This final feature is then passed through a linear layer and then a “Softmax” to produce 256-dimensional vector of probabilities for each of 256 possible 8-bit occupancy symbols.

FIG. 4 illustrates such a deep entropy coding module 40 in an encoder. In FIG. 4, Feature Extractor 41 refers to MLP⁽⁰⁾, Sibling Feature Extractor 42 denotes the MLP^{(sib)}, while the remaining MLPs are bundled together in Feature Aggregator 43. The first MLP in our model is five layers deep with 128-dimensional hidden features. All hidden MLPs consist of three residual layers and the same 128-dimensional hidden features. The additional MLP(sib) is a single layer MLP also having 128-dimensional hidden feature. The final linear layer produces a 256-dimensional output followed by Softmax to produce 256-dimensional probability vector. The layers in all MLPs are linear layers followed by a ReLU, without normalization.

Even though the proposed deep entropy model operates nodewise and uses deep features from ancestor nodes, during encoding process each MLP can be executed in parallel on all nodes. This is because the deep features used from ancestors are the output of the previous MLP module. While using the deep entropy model during decoding, however, one must fully decode the ancestor nodes before moving down the octree, and thus one can operate on (i.e., decode) in parallel only over sibling nodes. Consequently, all embodiments in this disclosure have the same capabilities: during encoding models can operate in parallel over all nodes, during decoding models can operate in parallel only over sibling nodes.

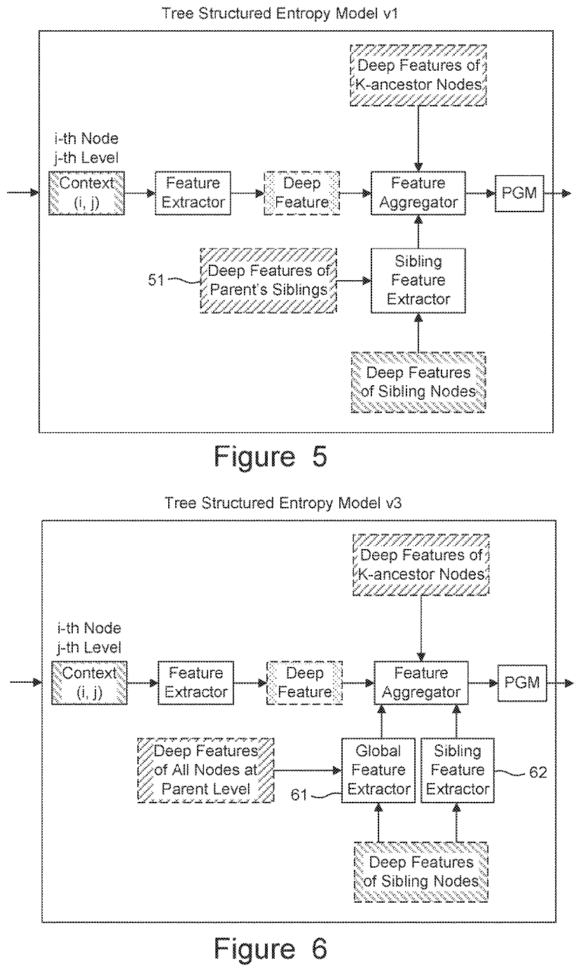

FIG. 5 shows an implementation of the deep entropy coding module, according to a second embodiment of the present principles. Compared to the first embodiment, in this architecture, MLP(sib) 42 (used to gather features of all siblings in the first embodiment) gathers the deep feature of the parent node 51 and all of its siblings under the same grandparent node. This produces richer deep features that contain more information from the parent level with no additional parameters required as the MLP is being shared.

In a third embodiment of the present principles, richer features can be extracted from the parent level by utilizing features from all nodes at the parent level instead of just the parent's siblings. Utilizing features from all nodes at the higher level produces a feature vector representing the coarse global topology of the object comprising the point cloud.

FIG. 6 shows an implementation of the deep entropy coding module, according to a fourth embodiment of the present principles. In this implementation, a first MLP 62 gathers the deep features from all siblings of a particular node and a second MLP 61 gathers features from all nodes at the parent level. The two MLPs operate at different scales. MLP 62 processes local information within a neighborhood and MLP 61 extracts information from the global manifold shape. Due to this difference in scales, a separate MLP^{(pa)} 61 is introduced to gather features at the parent level.

A fifth embodiment of the present principles is based on the previous embodiments. However, other than converting the raw point cloud to an octree structure, this embodiment allows the usage of other tree representations, such as QTBT or prediction tree, for example.

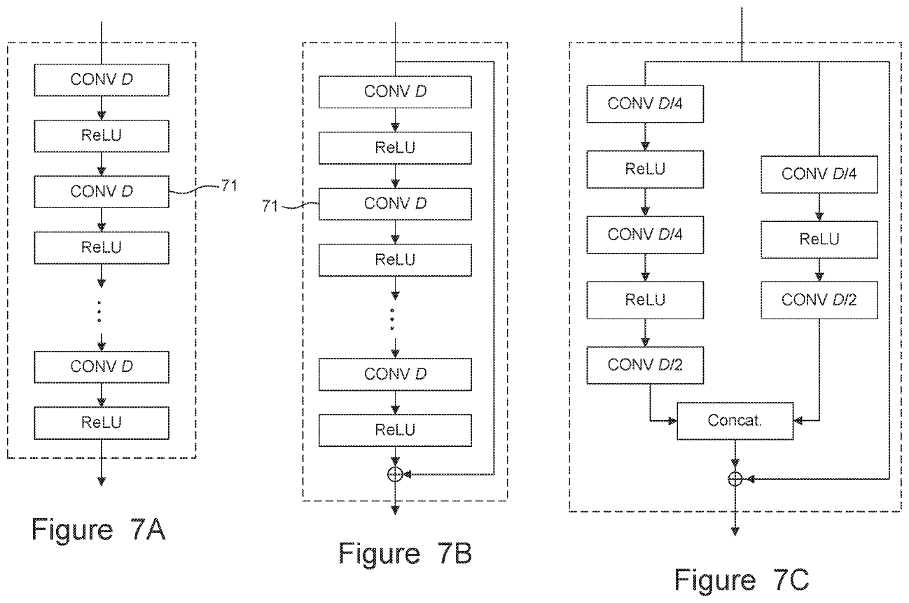

FIGS. 7A, 7B and 7C illustrate a sixth embodiment of the present principles. This sixth embodiment is based on embodiments 1 to 4. However, rather than using MLPs to extract and propagate the features for each node at each octree level, more advanced architectures like convolutions, sparse convolutions, ResNet (residual network), Inception ResNets, and transformers (attention-based models), for example. They can also be used for extracting and propagating the features. This is motivated to provide an enhanced feature aggregation capability.

In a first variant of the sixth embodiment, the feature extractor is a series of sparse 3D convolutional layers with a ReLU activation function following every 3D convolution, as shown in FIG. 7A. CONV D 71 denotes a sparse 3D convolution layer with D output channels.

In a second variant of the sixth embodiment, the feature aggregation module takes the ResNet architecture, as illustrated in FIG. 7B. In this example, it shows the architecture of a ResNet block to aggregate features with D channels. Compared to the first variant of FIG. 7A, the second variant of FIG. 7B introduces a residual connection from the input and added with the output of the convolutional layers.

In a third variant of the sixth embodiment, the feature aggregation module takes the Inception-ResNet (IRN) architecture, as shown in FIG. 7C. In this example, it shows the architecture of an IRN block to aggregate features with D channels.

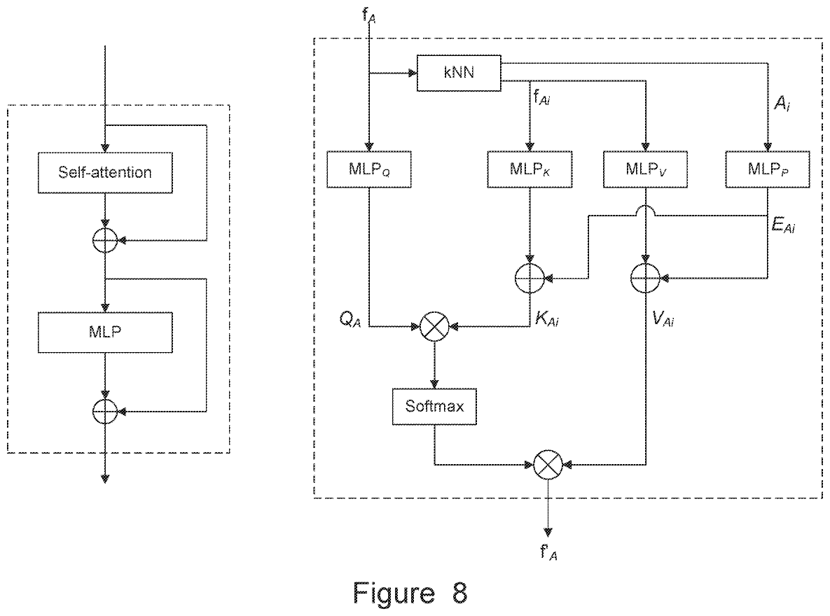

FIG. 8 diagrammatically shows a transformer block used in a fourth variant of the sixth embodiment of the present principles. In this variant, the feature propagation module takes the form of transformer architecture similar to a voxel transformer, as proposed, for example, in “Voxel transformer for 3d object detection” by Mao, Jiageng, et al. in Proceedings of the IEEE/CVF International Conference on Computer Vision. 2021. The transformer block of FIG. 8 consists of a self-attention block with residual connection, and a MLP block (consisting of MLP layers) with residual connection. Given a current feature vector f_{A} associated with a voxel location A, and its neighboring k features f_{Ai} associated with voxel locations Aᵢ, where Aᵢ (0≤i≤k−1) are the k nearest neighbors of A in the input sparse tensor, the self-attention block endeavors to update the feature f_{A} based on all the neighboring features f_{Ai}. Firstly, the points Aᵢ are obtained by a k nearest neighbor (kNN) search based on the coordinate of A. Then the query embedding Q_{A} for A is computed with:

$${Q}_{A} = {MLP}_{Q} ( {f}_{A} ) ,$$

After that, the key embedding K_{Ai} and the value embedding V_{Ai} of all the nearest neighbors of A are computed:

$${K}_{{A}_{i}} = {MLP}_{K} ( {f}_{{A}_{i}} ) + {E}_{{A}_{i}} , {V}_{{A}_{i}} = {MLP}_{V} ( {f}_{{A}_{i}} ) + {E}_{{A}_{i}} , 0 \leq i \leq k - 1 ,$$

where MLP_{Q}(⋅), MLP_{K}(⋅), and MLP_{V}(⋅) are MLP layers to obtain the query, key, and value respectively, and E_{Ai} is the positional encoding between the voxels A and Aᵢ, calculated by:

$${E}_{{A}_{i}} = {MLP}_{P} ( {P}_{A} - {P}_{{A}_{i}} ) ,$$

where MLP_{P}(⋅) is MLP layers to obtain the positional encoding, P_{A} and P_{Ai} are 3-D coordinates, they are centers of the voxels A and Aᵢ, respectively. The output feature of location A by the self-attention block is:

$${f}_{A}^{′} = {\sum }_{i = 0}^{k - 1} σ ( \frac{{Q}_{A}^{T} \cdot {K}_{i}}{c \sqrt{d}} ) \cdot {V}_{{A}_{i}} ,$$

where σ(⋅) is the Softmax normalization function, d is the length of the feature vector f_{A} and c is a pre-defined constant.

The transformer block updates the feature for all the occupied locations in the sparse tensor in the same way and then outputs the updated sparse tensor. A simplified embodiment, MLP_{Q}(⋅), MLP_{K}(⋅), MLP_{V}(⋅), and MLP_{P}(⋅) may contain only one fully-connected layer, which corresponds to linear projections.

In a variant, several feature aggregation blocks can be cascaded together in series to further enhance the performance. The feature aggregation blocks can be of the same type, for instance, all of them are transformer blocks. In this case, the parameters of their neural network layers can either be shared or not shared. The feature aggregation blocks can also be a mixture of different types of feature aggregation blocks, for example, a mixture of the IRN blocks and the transformer blocks.

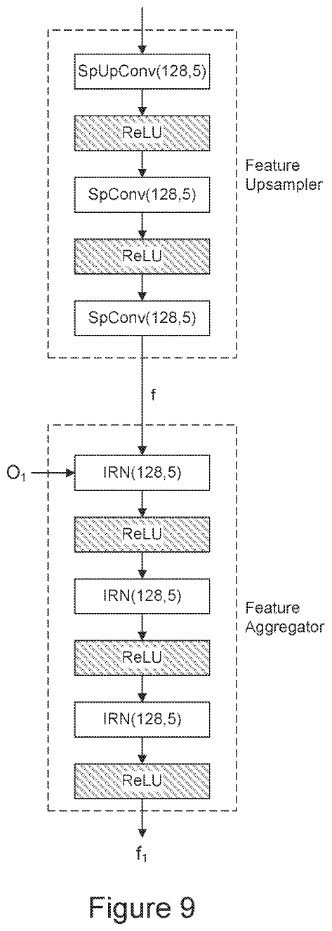

FIG. 9 illustrates a deep entropy coding/decoding method where the features from the parent level are up-sampled to match the resolution of the current octree level. These up-sampled features are propagated to the child nodes for deep occupancy probability estimation. The features from the parent level are already available when encoding/decoding for nodes at the current level. The features from the parent level are up-sampled to obtain distinctive features for all child nodes at the current level. This up-sampling can be performed via an MLP-based module which takes a feature vector and an index corresponding to the child node to output a feature for the corresponding child node, or via a regular or sparse convolution-based module which takes the whole feature map at the parent level and outputs an up-sampled feature map with features for all nodes at the current level. Then, this feature can be paired (concatenated or added) to a feature of the current node obtained from its neighborhood occupancy information via an MLP or regular/sparse convolution-based module. Later, this combined feature can again be propagated through any feature aggregator architecture (as proposed in the sixth embodiment) to arrive at a final deep feature. This deep feature is used by the probability generation module (PGM) to output the predicted probabilities for each bytewise occupancy symbol. Moreover, the deep feature is also sent off to the next level to be used as its Parent Feature.

In a variant, for reduced complexity, the up-sampled feature is combined directly with the context information (occupancy status, node location, etc.) at the current level (instead combining with the feature obtained through the context), and this combined feature is propagated to obtain the final deep feature. FIG. 9 illustrates the feature up-sampler and the feature aggregator modules. The feature up-sampler is composed of sparse convolution and sparse up-sampling convolution layers (as in the sixth embodiment), and the feature aggregator is composed of several Inception-ResNet layers (as stated in the sixth embodiment).

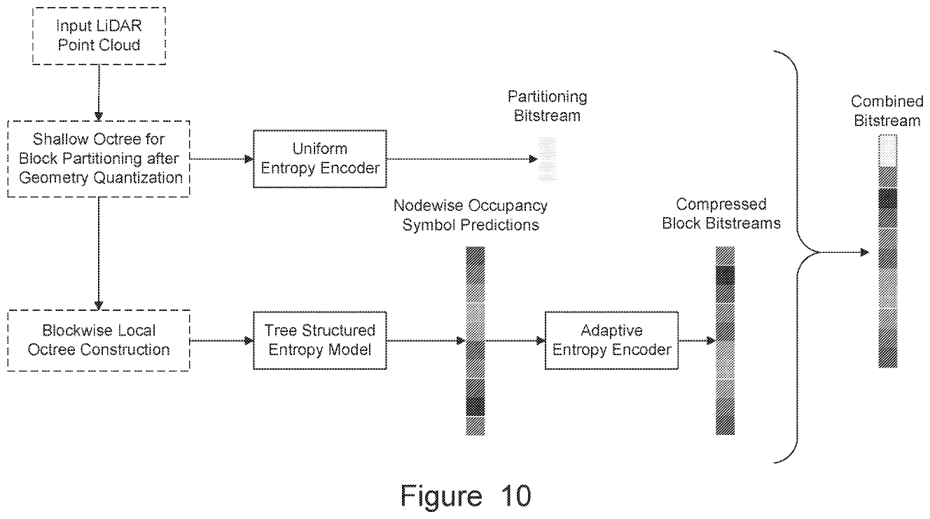

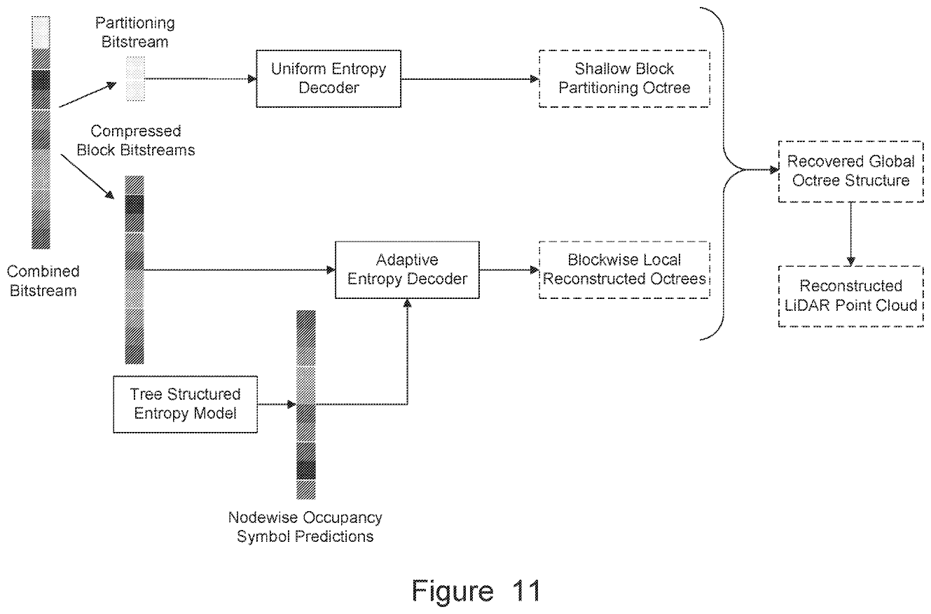

FIGS. 10 and 11 illustrate a scenario of the present principles in which the raw point cloud is converted into blocks via a shallow octree. Embodiments 1 to 7 relate to the scenario of converting the whole point cloud into a single octree representation and compressing this octree in a lossless manner. However, this procedure becomes increasingly time consuming and computationally expensive as the geometry data precision and the density of points in the point cloud increases. Moreover, the process of converting the raw data into octree representation takes longer as well. To deal with this issue, this eighth embodiment, the raw point cloud is first converted into blocks via a shallow octree, bringing the data points in each block from the original coordinates to the local block coordinates (by shifting the origin for each block), and finally converting each block data into a separate octree. With this procedure, each block contains a smaller part of the point cloud which can be converted to an octree faster and in parallel for each block. After lossless compression and decompression, the recovered points from each block are combined and brought back into the original coordinates. The auxiliary information from the shallow octree regarding the block partitioning is also compressed using uniform entropy coding and added to the bitstream.

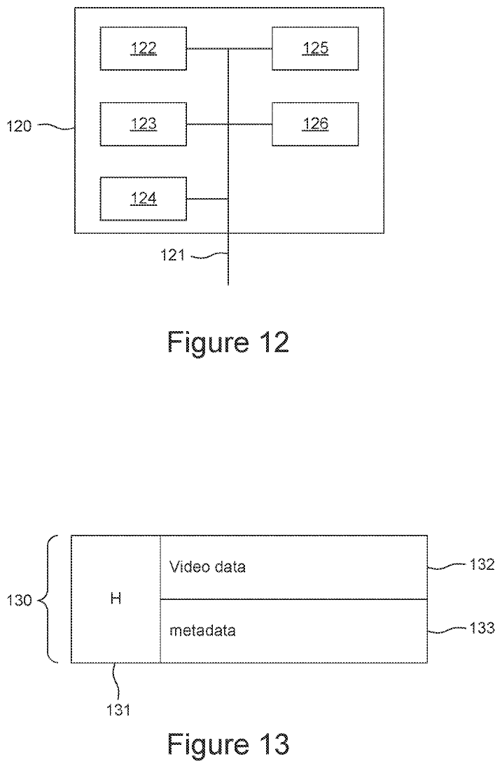

FIG. 12 shows an example architecture of a device 120 which may be configured to implement an encoding and/or decoding method described in relation to FIGS. 1-11. Alternatively, each circuit of an encoder and/or a decoder according to the present principles may be a device according to the architecture of FIG. 12, linked together, for instance, via their bus 121 and/or via I/O interface 126.

Device 120 comprises the following elements that are linked together by a data and address bus 31:
a microprocessor 122 (or CPU), which is, for example, a DSP (or Digital Signal Processor);
a ROM (or Read Only Memory) 123;
a RAM (or Random Access Memory) 124;
a storage interface 125;
an I/O interface 126 for reception of data to transmit, from an application; and
a power supply, e.g., a battery.

In accordance with an example, the power supply is external to the device. In each of mentioned memory, the word «register» used in the specification may correspond to area of small capacity (some bits) or to very large area (e.g., a whole program or large amount of received or decoded data). The ROM 123 comprises at least a program and parameters. The ROM 123 may store algorithms and instructions to perform techniques in accordance with present principles. When switched on, the CPU 122 uploads the program in the RAM and executes the corresponding instructions.

The RAM 124 comprises, in a register, the program executed by the CPU 122 and uploaded after switch-on of the device 120, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 120 is configured to implement a method described in relation to FIGS. 9 and 10, and belongs to a set comprising:
a mobile device;
a communication device;
a game device;
a tablet (or tablet computer);
a laptop;
a still picture camera;
a video camera;
an encoding chip;
a server (e.g., a broadcast server, a video-on-demand server or a web server).

FIG. 13 shows an example of an embodiment of the syntax of a stream when the data are transmitted over a packet-based transmission protocol. FIG. 13 shows an example structure 130 of a volumetric video stream. The video stream is structured as a container which organizes the stream in independent elements of syntax. The structure may comprise a header part 131 which is a set of data common to every syntax element of the stream. For example, the header part comprises some of metadata about syntax elements, describing the nature and the role of each of them. The structure comprises a payload comprising an element of syntax 132 and at least one element of syntax 133. Syntax element 132 comprises data representative of the tree-structured point clouds of a sequence of point clouds. The tree-structured point clouds have been compressed according to a deep entropy compression method.

Element of syntax 133 is a part of the payload of the data stream and may comprise metadata about how frames of element of syntax 42 are encoded. Such metadata may be associated with each frame of the video or to group of frames (also known as Group of Pictures (GoP) in video compression standards).

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
obtaining a tree-structured point cloud from a bitstream;
for each node of the of tree-structured point cloud:
initializing context information for the node;
predicting an occupancy symbol distribution for the node by using a learning-based entropy model utilizing the context information of the node and feature information from neighboring nodes and a parent node previously obtained from the bitstream;
decoding an occupancy symbol for the node, using an adaptive entropy decoder based on the occupancy symbol distribution; and
outputting an expanded tree based on the occupancy symbol.

2. (canceled)

3. The method of claim 1, wherein the entropy model uses feature information of sibling nodes of a parent of the node through a learning-based module used for siblings of the node to predict the occupancy symbol distributions.

4. The method of claim 1, wherein the entropy model uses feature information of all nodes at a parent level through a learning-based module used for siblings of the node, to predict the occupancy symbol distributions.

5. The method of claim 1, wherein the entropy model uses feature information of all nodes at a parent level through a separate learning-based module, to predict the occupancy symbol distributions.

6. The method of claim 1, wherein the point cloud is structured as an octree.

7. A device comprising a memory associated with a processor configured for:
obtaining a node of a tree-structured point cloud from a bitstream;
for each node of the of tree-structured point cloud;
initializing context information for the node;
predicting an occupancy symbol distribution for the node by using a learning-based entropy model utilizing the context information of the node and feature information from neighboring nodes and a parent node previously obtained from the bitstream;
decoding an occupancy symbol for the node, using an adaptive entropy decoder based on the occupancy symbol distribution; and
outputting an expanded tree based on the occupancy symbol.

8. (canceled)

9. The device of claim 7, wherein the entropy model uses feature information of sibling nodes of a parent of the node through a learning-based module used for siblings of the node, to predict the occupancy symbol distributions.

10. The device of claim 7, wherein the entropy model uses feature information of all nodes at a parent level through a learning-based module used for siblings of the node, to predict the occupancy symbol distributions.

11. The device of claim 7, wherein the entropy model uses feature information of all nodes at a parent level through a separate learning-based module, to predict the occupancy symbol distributions.

12. The device of claim 7, wherein the point cloud is structured as an octree.

13. A method comprising:
obtaining a point cloud structured as a tree;
for each node of the tree;
initializing context information;
predicting an occupancy symbol distribution by using a learning-based entropy model utilizing the context information of the node and feature information from neighboring nodes and a parent node of the node;
encoding, into a bitstream, an occupancy symbol by using an adaptive entropy encoder based on the occupancy symbol distribution; and
generating a combined bitstream for the tree.

14. The method of claim 13, wherein the entropy model uses feature information of sibling nodes of a parent of the node through a learning-based module used for siblings of the node, to predict the occupancy symbol distributions.

15. The method of claim 14, wherein the entropy model uses feature information of all nodes at a parent level through a learning-based module used for siblings of the node, to predict the occupancy symbol distributions.

16. The method of claim 14, wherein the entropy model uses feature information of all nodes at a parent level through a separate learning-based module, to predict the occupancy symbol distributions.

17. The method of claim 14, wherein the entropy model first up-samples the feature information from a parent level of each node to match a level of each node.

18. The method of claim 14, wherein the point cloud is structured as an octree.

19. A device comprising a memory associated with a processor configured for:
obtaining a point cloud structured as a tree;
for each node of the tree;
initializing context information;
predicting an occupancy symbol distribution by using a learning-based entropy model utilizing the context information of the node and feature information from neighboring nodes and a parent node of the node;
encoding, into a bitstream, an occupancy symbol by using an adaptive entropy encoder based on the occupancy symbol distribution; and
generating a combined bitstream for the tree.

20. The device of claim 19, wherein the entropy model uses feature information of sibling nodes of a parent of the node through a learning-based module used for siblings of the node, to predict the occupancy symbol distributions.

21. The device of claim 19, wherein the entropy model uses feature information of all nodes at a parent level through a learning-based module used for siblings of the node, to predict the occupancy symbol distributions.

22. The device of claim 19, wherein the entropy model uses feature information of all nodes at a parent level through a separate learning-based module, to predict the occupancy symbol distributions.

23. The device of claim 19, wherein the entropy model first up-samples the feature information from a parent level of each node to match a level of each node.

24. The device of claim 19, wherein the point cloud is structured as an octree.
